(19) United States
(12) Patent Application Publication
(10) Pub. No.: US 2002/0119218 A1
(43) Pub. Date: Aug. 29, 2002

(54) Method & apparatus of electric cleansing of food products

(76) Inventors: Earl P. Burke JR., Houston, TX (US); George Nelson Bennett, Houston, TX (US); David Richard Jackson, Houston, TX (US)

Correspondence Address: CONLEY ROSE & TAYON, P.C., P. O. BOX 3267, HOUSTON, TX, 77253-3267, US

(21) Appl. No.: 09/747,067

(22) Filed: Dec. 21, 2000

(51) Int. Cl. A21D 2/14

(52) U.S. Cl. 426/24

(57) ABSTRACT

A method and related apparatus for cleansing or killing bacteria from raw oysters. The method involves exposing the meat, and possibly some natural fluids, of shucked oysters to high strength electric fields to cleanse or kill the bacteria present in and on the oyster. An apparatus to perform the method involves a sterilization tank made in part of two conductive plates spaced about one centimeter apart. The meat of shucked oysters is placed between the plates. A large voltage from energy-storing capacitors is applied to the conductive plates to create the electric field that kills the bacteria in the stomach and other cavities, and on the meat of the shucked oysters.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to electric cleansing of food products. More particularly, the invention relates to the use of electric fields and currents to kill bacteria associated with bivalves. More particularly still, the invention relates to the cleansing of bacteria from oysters by use of electric fields and currents.

2. Description of the Related Art

In recent years, bivalves (which may include scallops, abalone, shrimp, crabs, crawfish, and conch snails) or shellfish, especially oysters, have been linked with several harmful forms of bacteria. The most well known of those bacteria are E. coli and salmonella, although these are not linked solely with shellfish. Free living marine vibrios including Vibrio vulnificus and Vibrio parahaemolyticus are bacteria which may also be present in and on oysters that has received so much attention from the media in recent years that oyster sales have dropped significantly because of the negative publicity.

There are several ways to kill these bacteria generally, and on oysters particularly. The easiest way to kill the bacteria is to cook the oyster, for example by boiling or deep frying. However, one of the more popular ways to eat an oyster is in its raw state, exposing the consumer to these harmful bacteria. In an effort to kill the bacteria with a minimum effect on the flavor of the oyster, at least two prior art methods have been developed. The first method is a pressure treatment method, and the second involves alternatively subjecting the oyster to heat and cold.

The pressure treatment method of killing bacteria involves taking the oysters in their shells and placing them within a pressure vessel. After the vessel is sealed, a relatively high pressure is applied to the oysters over an extended period of time, i.e., minutes. This high pressure tends to kill vibrio vulnificus, but does not kill E. coli or salmonella. Further, the pressure method has several detrimental effects. The first such detrimental effect is cracking the shell of the oyster. Shellfish, as the name would imply, are contained within a hard shell composed mostly of calcium. A cracked shell causes loss of the internal or natural fluids of an oyster, which fluids enhance the flavor of an oyster eaten raw, and kills the oyster, which shorten its shelf life. Further the cracked shell could allow for entry of harmful bacteria. These high-pressure machines are also relatively expensive to produce. The inventor of this patent is aware of a prototype pressure machine capable of pressure cleansing at least 60 pounds of oysters in their shell, which prototype was estimated to cost approximately $1.25 million.

The second prior art technique for killing bacteria is the exposure of the oyster to alternative heat and cold. Ideally, the heat exposure temperature would be sufficiently low to not cook the meat of the oyster itself, or if the exposure temperature is high, the exposure time would not be sufficient to cook the meat. Once exposed to the high temperatures, the oyster is then subjected to relatively low temperatures. It is assumed the extreme temperature swing causes death of the harmful bacteria in the oyster. Although this method is theoretically viable, exposure of the meat of the oyster within the shell to the high temperatures tends to cook the oyster, even if slightly, such that the flavor and appearance is changed. That is, someone accustomed to the flavor and appearance of a genuinely raw oyster may be dissatisfied with the flavor of an oyster that has had bacteria eliminated by the alternative hot and cold treatment method.

Thus, what is needed is a way to cleanse or kill all the bacteria from bivalves, particularly oysters, that does not in any significant way impair the flavor or appearance of the raw oysters.

### SUMMARY OF THE INVENTION

The problems noted above are solved in large part by an electric cleansing apparatus and method that involves exposing the meat of raw oysters to an electric field. The cleansing of the oysters is preferably accomplished in a batch mode where a certain volume of shucked oysters are placed in a container having two substantially parallel conductive plates, or electrodes, spaced approximately one centimeter apart forming two of its walls. After the oysters are placed in the treatment chamber, a large voltage is applied to the plates which creates an electric field between the plates on the order of 15,000 volts per centimeter (V/cm), and causes current flow between the plates and through the oysters. The electric field kills the bacteria by rupturing the cell wall membrane, but it is possible too that the current flow aids the process. The voltage and current pulses applied are of a sufficiently short duration, on the order of 500 micro-seconds (μs) per pulse, so as not to induce significant temperature change, thus cooking the oysters. Because of the simplicity of the apparatus to perform such electric cleansing, the method may be performed not only in the large volume of an oyster processing facility, but may also be adapted for use on smaller scales by restaurants specializing in such seafood delicacies, and for personal use in homes.

The structure to perform the method disclosed herein comprises generally of a connection to a low voltage supply of power. A step-up transformer converts the low voltage power to a much higher voltage. A capacitor stores energy this higher voltage energy until such time as a volume of oysters is in a treatment chamber ready for treatment. At this time, the energy stored on the capacitor is coupled to plates or electrodes forming at least two walls of a treatment chamber. The voltage on the capacitor is thus transferred to the plates, creating an electric field and current flow between them. This application may be performed one or more times. At least the electric field, and possibly the electric current flow, causes the bacteria in the oysters to be eliminated.

Thus, the present invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is an electrical schematic of an embodiment of the present invention;

FIG. 2 is an equivalent circuit electrical schematic of the capacitor, tank, and switch combination;

FIG. 3 is a graph showing voltage as a function of time applied across the conductive plates of the treatment chamber;

FIG. 4 is a partial perspective view of a fluid strainer;

FIG. 5 is a perspective view of a treatment chamber;

FIG. 5A is a cut-away perspective view of the treatment chamber taken substantially along line 5A-5A of FIG. 5; and

FIG. 5B is a perspective view, with hidden components shown in dashed lines, of a second embodiment of a treatment chamber.

### NOTATION AND NOMENCLATURE

Certain terms are used throughout the following description and claims to refer to particular system components. As one skilled in the art will appreciate, different companies or individuals may refer to components by different names. This document does not intend to distinguish between components that differ in name, but not in function. In the following discussion and in the claims, the terms “including” and “comprising” are used in an open-ended fashion, and thus should be interpreted to mean “including, but not limited to . . . . ” Also, in at least the electrical construction context, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENT

An embodiment of the present invention addresses the problems associated with the bacteria within the digestive track and on the bodily surface of the oyster by exposing the oyster to an electric field of sufficient strength to kill the bacteria. In particular, these bacteria could comprise E. coli, salmonella, and the free living marine vibrios including Vibrio vulnificus and Vibrio parahaemolyticus. Before delving into the specifics of an apparatus for, and method of, accomplishing this task, a brief digression into oyster processing is required so as to describe preferably where the improvements described herein are utilized in this process.

The process of harvesting oysters for human consumption is very labor-intensive. First, the oysters are harvested from oyster beds and brought to facilities known as shucking houses. The oysters, still in their shells, are placed in sacks within large coolers to keep their temperature low in an effort to keep the oyster alive as long as possible. From the coolers, the oysters are moved to workers who have the task of opening, or shucking, the shells from the oyster and cutting out the oyster's body or meat. The meat and the internal or natural fluids contained within the shell are then poured into a bucket at the shucking station. When the bucket becomes full of shucked oysters and their related fluids, workers take the bucket to a rinsing or skimming table.

At the rinsing or skimming table, workers rinse the oysters with tap water, or otherwise clean water. The first purpose of this rinsing step is to remove dirt, sand and small pieces of shell that may be present in the raw oysters because of the environment in which they live and the nature of shucking the oyster from the shell. The second reason for rinsing the oysters is that it is believed that such rinsing may reduce the presence of bacteria, at least on the outer surfaces of the oysters. After the rinsing step, workers place the oysters, by weight, into shipping containers. Once the shipping container contains the correct weight of oysters, tap water fills the remaining volume and the container is packed in ice for shipping. However, rinsing the oysters in tap water, and likewise filling the remaining volume in the shipping containers with tap water, presents additional problems.

The first of the at least two problems associated with the rinsing in tap water has to do with flavor of the oysters when eaten raw. As mentioned above, those accustomed to eating raw oysters directly from the shell suggest that part of the raw oyster experience is the consumption of the natural fluids present with the oyster meat in the shell. This may be, to some extent, sea water and other natural fluids of the oyster. The process of rinsing the shucked oyster in tap water not only removes the unwanted dirt, sand and shell particles, but also removes most of their natural fluids present in and on the oyster. Thus, even if an oyster is eaten only minutes after being shucked, if the meat is rinsed in tap water, the raw oyster experience may be lessened to some extent because of the removal of the natural fluids of the oyster.

The second short-coming of the rinsing of raw oysters in tap water is the supposed cleansing effect. Because of the highly publicized, but rare occurrence, of humans becoming sick based on the consumption of bacteria associated with raw oysters, most restaurants and shucking houses wash the oysters before serving them. This washing is an effort to reduce the likelihood of human consumption of the harmful bacteria. While some of the harmful bacteria noted above may be present on outer surfaces of the oyster, some of those bacteria, including the vibrios, may generally be found in the digestive track of the oyster. So, while rinsing the oyster clean of fluids present with the meat in the shell may eliminate some of the harmful bacteria, this step does little or nothing to remove the harmful bacteria contained within the oyster.

An improved method of harvesting and preparing raw oysters for human consumption preferably involves modification of the process described above between the rinsing or skimming phase and the packing phase of the oyster preparation process. More particularly, an embodiment of the present invention involves electric cleansing of the rinsed oysters that have yet to be packed and weighed. After the raw oysters have been rinsed, workers preferably place the oysters in a generally rectangular electric sterilization chamber formed on opposing substantially parallel sides by plates of conductive material preferably having a separation of one centimeter (cm), but other separations are possible. The walls of the chamber connecting the plates of conductive material are preferably non-conductive. A bottom portion of the chamber preferably contains a door mechanism, which is also preferably of a non-conductive material. The door is preferably adapted to selectively open and close, and is also preferably perforated with holes large enough to allow fluids to exit the sterilization chamber, but small enough to hold the oysters in the chamber. Alternatively, the door mechanism could be formed in one of the sides, and still be within the contemplation of this invention. Once the treatment chamber is full, a large voltage is preferably placed across the opposing conductive plates sufficient to create an electric field between them of 15,000 volts per centimeter (V/cm). Placing this large voltage across the plates has two simultaneous effects. First, the electric field is created, as just noted, between the plates proportional to the voltage applied and inversely proportional to the distance between the plates. Secondly, this voltage causes a current flow through the contents of the container, in this case oysters and their natural fluids. The electric field is the mechanism that kills the bacteria in and on the oyster. More particularly, the high-strength electric field ruptures the cell walls of the bacteria, thereby killing them. Likewise, it is believed that the electric current flow may aid in killing the bacteria.

Electric current flowing through the oysters causes heat to be generated. It is preferred that the heat generated within the container, that is the rise in temperature of the oysters and natural fluids, be kept to a minimum to decrease the likelihood that the oysters are cooked. This is preferably accomplished by having the relatively large electric field, discussed above, in combination with a short duration application time, preferably 500 micro-seconds (μs) per pulse. A structure to generate the necessary voltages, fields and currents is discussed in more detail below. By having the application time short, the total heat created in the oysters is kept low. Once the oysters in the container have had the electric field applied to them one or more times as required to kill the bacteria, the lower door preferably opens and the oysters are preferably placed in the shipping buckets as in the prior art. One embodiment involves filling the remaining volume of the bucket with tap water and shipping, just as in the prior art. However, as was not the case in the prior art, the oyster consuming public can be assured that the harmful bacteria including the E. coli, salmonella and the vibrios have been eliminated from the oyster products at least as of the time of shipping, thereby increasing consumer confidence in the product.

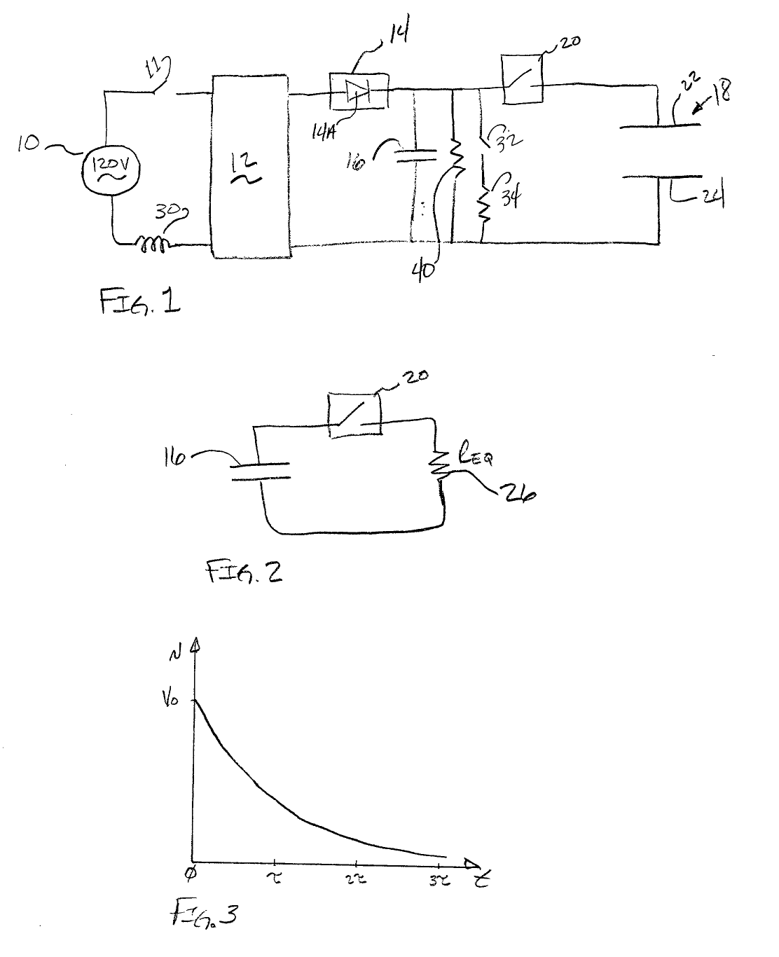

FIG. 1 describes an embodiment of a structure to generate the voltages and currents necessary to apply to the opposing plates of the treatment tank. An embodiment of the structure necessary to generate these voltages and currents preferably couples to a standard 120 volt RMS supply 10, common in most shucking houses, restaurants and homes. However, other supply voltages may be used, e.g., 220 and 480, and would still be within the contemplation of this invention. Voltage source 10 preferably supplies power to a charging network, through an on-off switch 11, that comprises a transformer 12, diode 14A, and capacitor 16. As the name implies, the step-up transformer 12 takes the voltage provided at the standard wall socket and increases it to a higher voltage. In an embodiment of this invention, the peak voltage output of the step-up transformer 12 is 15,000 volts (15 kV). The output of the step-up transformer 12 preferably couples to a rectification unit 14. In an embodiment of this invention, the rectification unit 14 is merely a diode 14A oriented within a circuit to perform half-wave rectification. It should be understood, however, that full-wave rectification is possible and indeed may be required, depending upon the charging current required for the capacitor 16. One skilled in the art of electronic and power devices will realize that the half or full wave rectification performed at the rectification unit 14 turns the alternating current (AC) into a direct current (DC) signal.

The energy transferred from the low voltage source 10 through the transformer 12 and rectification unit 14 preferably accumulates in high voltage capacitor 16. At such a time that the high voltage capacitor 16 is charged to its full capacity, and there is an available supply of oysters in the sterilization container or tank 18, the voltage control network, here high voltage power switch 20 preferably closes or otherwise becomes conductive, thereby applying the voltage and power stored in the high voltage capacitor 16 across the tank 18. One of ordinary skill in the art recognizes that a timer, or other circuit, coupled to the high voltage power switch 20 could be used to activate the circuit for applying multiple pulses to the oysters within the sterilization chamber. The positive side of the voltage stored on the high voltage capacitor 16 couples to a first electrode or conductive plate 22 of the tank 18, while the negative side of the voltage stored across the capacitor 16 couples to a second electrode or conductive plate 24 of the tank 18. In this way, a large voltage is applied to the plates which thereby creates an electric field between them. As the voltage develops across the conductive plate 22 and 24, electric current flows through the oysters.

Also shown in FIG. 1 is current limiting inductor 30. The purpose of current limiting inductor 30 is to limit the charging current through the transformer primary winding. Current-limiting resistors or capacitors could also be used. The combination of discharge resistor 34 and safety switch 32 are preferably used to quickly discharge the energy stored on capacitor 16 when the system is no longer in use. Also shown is high voltage resistor 40, which serves to insure discharge of the capacitor 16 when the system is not in use for extended periods of time. Some, or all, of the high voltage components that couple to the capacitor may be commercially available as self-contained high-voltage power units.

One skilled in the art of electronic circuits or power supplies realizes that the voltage applied across the plates in the embodiment shown in FIG. 1 is not constant. FIG. 2 shows an equivalent circuit of the sterilization tank filled with oysters and capacitor for purposes of explanation. Shown in FIG. 2 is the capacitor 16 couples to an equivalent resistance 26 by way of high voltage switch 20. The equivalent resistance 26 represents the resistance of the oysters to be cleansed in the sterilization container or tank 18. That is, the oysters, in electrical contact with the conductive plates of the sterilization tank, have some resistance to electrical current flow, similar to that of an electrical resistor. Thus, if the capacitor 16 is charged to an initial voltage, upon closing high voltage switch 20, that peak voltage is applied across the resistance 26, and the voltage then decays over time. More particularly, assuming an initial voltage of V₀ at time t=0, the voltage across the equivalent resistance in a circuit shown in FIG. 2 is mathematically illustrated by the equation:

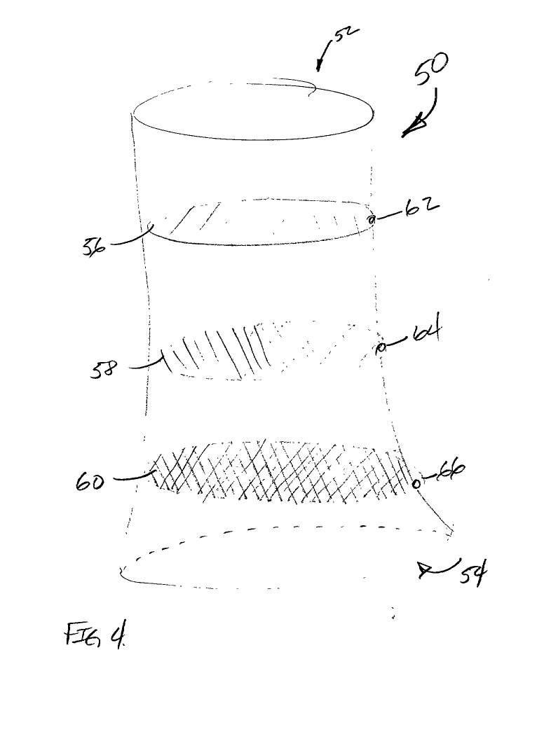

v(t)=V₀e^{-t/τ} (1)

where v(t) is the voltage applied to the equivalent resistance as a function of time, V₀ is the initial voltage and τ=R_{eq}C, as one of ordinary skill in the electrical arts is fully aware. FIG. 3 shows an exemplary graph of voltage across the equivalent resistance 26 as a function of time, assuming that the voltage is charged to the level V₀ at the time the high voltage switch 20 is closed at t=0. As is seen in FIG. 3, the voltage applied initially is that of V₀ and decreases or decays exponentially. In fact, the voltage across the equivalent resistance 26 is greatly reduced after an elapse of about five time constants τ. Thus, the electric field generated is not constant over the application time.

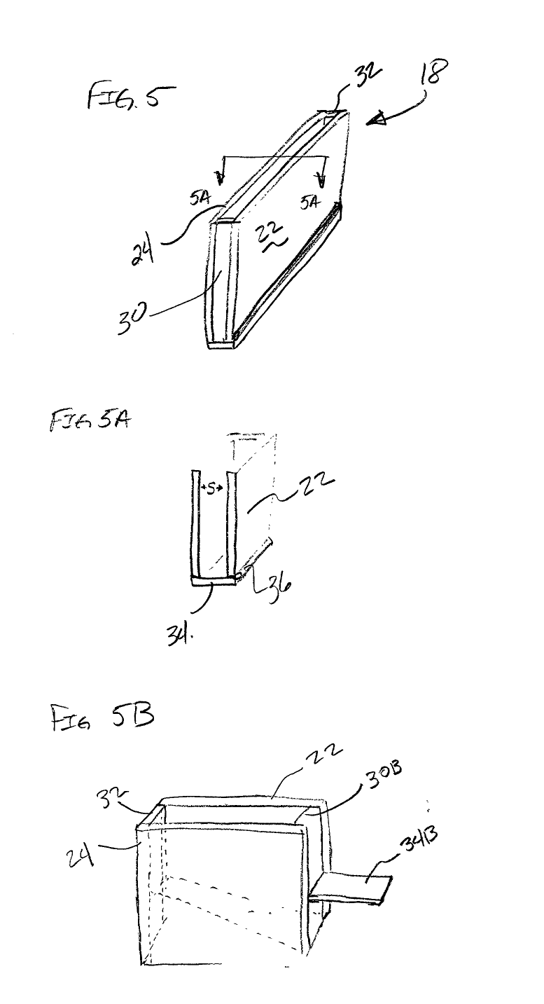

FIG. 5 shows in greater detail an embodiment of the treatment chamber 18. Substantially parallel conductive plates 22 and 24 define two sides of the treatment chamber 18. As discussed with respect to FIG. 1, it is upon these plates that the voltage from capacitor 16 (not shown in FIG. 5) is coupled which creates an electric field between them. The remaining two vertical members 30 and 32 attach to the plates 22 and 24 at substantially right angles. Members 30 and 32 are preferably made of substantially non-conductive material. FIG. 5A, a cross-section of FIG. 5 along lines 5A-5A, shows in better detail the preferred relationship between the plates 22 and 24, as well as the preferred relationship of the plates to the lower door 34. Just as the non-conductive vertical members 30 and 32, lower door 34 is preferably non-conductive material. After treatment of oysters within chamber 18, lower door 34 preferably opens to allow removal of the cleansed contents. In FIG. 5A, the door 34 preferably opens by rotating door 34 about a hinge 36. Although hinge 36 is shown to be attached to conductive plate 22, the hinge may be attached to either electrode 22 or 24, or the non-conductive members 30 and 32, and still be within the contemplation of this invention. Further, rather than hinging, door 34 could also slide horizontally to allow the contents of chamber 18 to be removed, and still be within the contemplation of this invention.

FIG. 5A also exemplifies the spacing S between conductive plates 22 and 24. In one embodiment, spacing S is preferably one (1) centimeter. This spacing is sufficiently small to keep the necessary applied voltage on the plates (to achieve the preferred field strength of 15 kV/cm) to a manageable level. Also, the spacing provides good electrical contact of the oyster meat with the electrodes as this dimension is the approximate thickness of meat of a healthy raw oyster (the smallest dimension). However, other spacings and applied voltages may be used.

FIG. 5B shows an alternative embodiment of the application chamber 18. In particular, rather than having the door 34 on a lower portion of the treatment chamber 18, a door 34B is shown as part of side 30B. In this embodiment of the application chamber 18, once the electric field applied to the plates 22 and 24 has dissipated, the door 34B opens and the oysters and related fluids within the chamber flow outward through this door 34B based on a slope of a bottom portion of the chamber. It is noted that if the bottom portion of the chamber 18 is sloped, the electrodes 22 and 24 need not be square or rectangular or any other configuration, but may be modified to follow the angle of the incline.

The amount of heat generated in the oysters during the electric cleansing process is proportional to the conductivity of the oysters in the electric sterilization chamber, the square of the amplitude of the initial voltages, and the time constant. If more than one pulse is applied, then the total treatment time (the time constant multiplied by the number of applied pulses) becomes a controlling parameter in heat generation. Table 1, reproduced below, shows the conductivity of various substances related to the present invention.

TABLE 1
CONDUCTIVITY “σ” VALUES

| MEDIA | σ [S/m] |
|---|---|
| Tap water | 0.039 |
| Oysters packaged in water (packaged water removed) | 0.13 |
| Oysters packaged in water (with some packaged water) | 0.19 |
| Oysters packaged in water, some package water removed, | 0.25 |
| and the oysters soaked in tap water for five minutes | |
| Oysters packaged in water, package water removed, and the | 0.32 |
| oysters soaked in tap water for five minutes | |
| Oysters skimmed and packaged in natural fluids only | 0.30 |
| (natural fluids removed before testing) | |
| Oysters skimmed and packaged in natural fluids only | 0.36 |
| (some natural fluids present during testing) | |
| Oysters unskimmed and packaged in natural fluids only (natural | 0.40 |
| fluids removed before testing) | |
| Oysters unskimmed and packaged in natural fluids only | 0.54 |
| (some natural fluids present during testing) | |
| Oyster water (from oysters packaged in water) | 0.34 |
| Oyster natural fluids (skimmed) | 1.15 |
| Oyster natural fluids (not skimmed) | 1.20 |
| Ocean water (from tables) | 4.0 |

Table 1 shows that the conductivity σ of ordinary tap water is typically 0.039 Seimens per meter (“S/m”). The table further shows a range of conductivity for oysters, depending on whether those oysters are skimmed and in what type fluid they are packaged. The range of conductivity is from 0.13 S/m for oysters packaged in water, to 0.54 S/m for oysters that have yet to be rinsed or skimmed and still in their natural fluid. In an embodiment of the present invention, oysters are preferably electric cleansed after light skimming, giving the cleansed solution a conductivity of approximately 0.36 S/m and preferably requiring a treatment time of 500 μs per pulse, as described more fully below.

It must be understood that the amount of heat generated in the oysters during treatment is proportional to the conductivity. That is, for low conductivity (with applied voltage held constant), less heat is generated because less current flows in the oysters. Likewise, for higher conductivity, greater current flows and therefore the oysters must dissipate more power (become hotter). It is desirable to keep the amount of heat generated as low as possible.

Although an embodiment of the present invention has been described as preferably applying an initial 15,000 V/cm of electric field to cleanse the oysters, it must be understood that the voltage on the capacitor may be greater or less than 15,000 volts to achieve this field strength. In one embodiment the spacing between the substantially parallel conductive plates 22 and 24 is one centimeter. In this case, the peak voltage applied to the capacitor 16 need only be 15,000 volts. However, if the spacing between the substantially parallel conductive plates 22 and 24 is increased, e.g., to two centimeters, then the peak voltage of the capacitor 16 must be 30,000 volts to achieve the preferred 15,000 V/cm field strength.

Not only must the capacitor peak voltage change dependant upon the spacing between the plates, but also its energy storage capability of the capacitor 16 must change depending on the volume of the sterilization chamber. That is to say, the energy needed to sterilize a relatively small volume, for example, less than one liter, is significantly less than the energy required to sterilize a significantly larger volume, e.g., greater than 10 liters, even if the spacing between the substantially parallel conductive plates is held constant.

Table 2 below exemplifies capacitor size, in micro-Farads (μF) versus conductivity (in S/m) of the material between the conductive plates, and the width and height (assumed to be equal) of the conductive plates, or electrodes 22 and 24.

TABLE 2
CAPACITOR SIZE VERSUS
CONDUCTIVITY AND ELECTRODE WIDTH

| Plate width (and | | 12.7 | 25.4 | 50.8 | 101.6 |
|---|---|---|---|---|---|
| height) in cm | | | | | |
| volume [liters] | | 0.161 | 0.645 | 2.58 | 10.32 |
| 0.1 | S/m | 16 μF | 65 μF | 258 μF | 1032 μF |
| 0.15 | S/m | 24 μF | 97 μF | 387 μF | 1548 μF |
| 0.2 | S/m | 32 μF | 129 μF | 516 μF | 2065 μF |
| 0.25 | S/m | 40 μF | 161 μF | 645 μF | 2581 μF |
| 0.3 | S/m | 48 μF | 194 μF | 774 μF | 3097 μF |
| 0.35 | S/m | 56 μF | 226 μF | 903 μF | 3613 μF |
| 0.4 | S/m | 65 μF | 258 μF | 1032 μF | 4129 μF |
| 0.45 | S/m | 73 μF | 290 μF | 1161 μF | 4645 μF |
| 0.5 | S/m | 81 μF | 323 μF | 1290 μF | 5161 μF |
| 0.55 | S/m | 89 μF | 355 μF | 1419 μF | 5677 μF |
| 0.6 | S/m | 97 μF | 387 μF | 1548 μF | 6194 μF |
| 0.65 | S/m | 105 μF | 419 μF | 1677 μF | 6710 μF |
| 0.7 | S/m | 113 μF | 452 μF | 1806 μF | 7226 μF |
| 0.75 | S/m | 121 μF | 484 μF | 1935 μF | 7742 μF |
| 0.8 | S/m | 129 μF | 516 μF | 2065 μF | 8258 μF |
| 0.85 | S/m | 137 μF | 548 μF | 2194 μF | 8774 μF |
| 0.9 | S/m | 145 μF | 581 μF | 2323 μF | 9290 μF |
| 0.95 | S/m | 153 μF | 613 μF | 2452 μF | 9806 μF |
| 1 | S/m | 161 μF | 645 μF | 2581 μF | 10323 μF |
| 1.05 | S/m | 169 μF | 677 μF | 2710 μF | 10839 μF |
| 1.1 | S/m | 177 μF | 710 μF | 2839 μF | 11355 μF |
| 1.15 | S/m | 185 μF | 742 μF | 2968 μF | 11871 μF |
| 1.2 | S/m | 194 μF | 774 μF | 3097 μF | 12387 μF |
| 1.25 | S/m | 202 μF | 806 μF | 3226 μF | 12903 μF |

This table assumes a spacing between the substantially parallel conductive plates, or electrodes, of one centimeter and a time constant of 100 μs. In order to obtain a 500 μs treatment time for this time constant, five pulses would be required. However, larger or smaller plate separations and different time constants could be used, and still be within the contemplation of this invention. One centimeter electrode spacing, however, appears to be sufficiently large to allow the meat of oysters to fit between the electrodes and still require only 15,000 volts peak to be applied to the electrodes. However, if a larger plate spacing is used, larger electrode voltages will be required as discussed above. The volume indicated is the volume between the two conductive plates.

Table 2 shows that as either the conductivity or the volume of oysters in the application chamber 18 increases, so too does the required size (energy storage capacity) of the capacitor. Likewise, even at constant conductivities, an increase in the volume of the application or sterilization chamber 18 alone results in an increased energy storage requirement for the capacitor. It is noted that the values given in Table 2 show capacitance values extending to 12,903 μF. While a capacitor of this size may theoretically be constructed, its size and cost may be prohibitive for a commercial scale electric sterilization chamber.

As mentioned above, the conductivity of the substance between the substantially parallel conductive plates, or electrodes 22 and 24, of the sterilization chamber 18, in part, controls or dictates the current flow for any given applied voltage. As the conductivity increases, so too does the current flow and likewise the temperature increases. Table 3 below shows the temperature increase (in degrees centigrade) of a substance between the electrodes 22 and 24 within a sterilization chamber 18 versus the conductivity of that substance in S/m, all as a function of treatment time. The field applied in each case is 15 kV/cm.

TABLE 3
TEMPERATURE INCREASE (° C.) VERSUS CONDUCTIVITY
(S/m) AND TREATMENT TIME (μs)

| | | 100 μs | 200 μs | 300 μs | 400 μs | 500 μs | 1000 μs | 1500 μs |
|---|---|---|---|---|---|---|---|---|
| 0.1 | S/m | 2.7° C. | 5.4° C. | 8.1° C. | 10.8° C. | 13.5° C. | 26.9° C. | 40.4° C. |
| 0.15 | S/m | 4.0° C. | 8.1° C. | 12.1° C. | 16.1° C. | 20.2° C. | 40.4° C. | 60.6° C. |
| 0.2 | S/m | 5.4° C. | 10.8° C. | 16.1° C. | 21.5° C. | 26.9° C. | 53.8° C. | 80.7° C. |
| 0.25 | S/m | 6.7° C. | 13.5° C. | 20.2° C. | 26.9° C. | 33.6° C. | 67.3° C. | 100.9° C. |
| 0.3 | S/m | 8.1° C. | 16.1° C. | 24.2° C. | 32.3° C. | 40.4° C. | 80.7° C. | 121.1° C. |
| 0.35 | S/m | 9.4° C. | 18.8° C. | 28.3° C. | 37.7° C. | 47.1° C. | 94.2° C. | 141.3° C. |
| 0.4 | S/m | 10.8° C. | 21.5° C. | 32.3° C. | 43.1° C. | 53.8° C. | 107.7° C. | 161.5° C. |
| 0.45 | S/m | 12.1° C. | 24.2° C. | 36.3° C. | 48.4° C. | 60.6° C. | 121.1° C. | 181.7° C. |
| 0.5 | S/m | 13.5° C. | 26.9° C. | 40.4° C. | 53.8° C. ° | 67.3° C. | 134.6° C. | 201.9° C. |
| 0.55 | S/m | 14.8° C. | 29.6° C. | 44.4° C. | 59.2° C. | 74.0° C. | 148.0° C. | 222.0° C. |
| 0.6 | S/m | 16.1° C. | 32.3° C. | 48.4° C. | 64.6° C. | 80.7° C. | 161.5° C. | 242.2° C. |
| 0.65 | S/m | 17.5° C. | 35.0° C. | 52.5° C. | 70.0° C. | 87.5° C. | 174.9° C. | 262.4° C. |
| 0.7 | S/m | 18.8° C. | 37.7° C. | 56.5° C. | 75.4° C. | 94.2° C. | 188.4° C. | 282.6° C. |
| 0.75 | S/m | 20.2° C. | 40.4° C. | 60.6° C. | 80.7° C. | 100.9° C. | 201.9° C. | 302.8° C. |
| 0.8 | S/m | 21.5° C. | 43.1° C. | 64.6° C. | 86.1° C. | 107.7° C. | 215.3° C. | 323.0° C. |
| 0.85 | S/m | 22.9° C. | 45.8° C. | 68.6° C. | 91.5° C. | 114.4° C. | 228.8° C. | 343.2° C. |
| 0.95 | S/m | 25.6° C. | 51.1° C. | 76.7° C. | 102.3° C. | 127.8° C. | 255.7° C. | 383.5° C. |
| 1 | S/m | 26.9° C. | 53.8° C. | 80.7° C. | 107.7° C. | 134.6° C. | 269.1° C. | 403.7° C. |
| 1.05 | S/m | 28.3° C. | 56.5° C. | 84.8° C. | 113.0° C. | 141.3° C. | 282.6° C. | 423.9° C. |
| 1.1 | S/m | 29.6° C. | 59.2° C. | 88.8° C. | 118.4° C. | 148.0° C. | 296.1° C. | 444.1° C. |
| 1.15 | S/m | 31.0° C. | 61.9° C. | 92.9° C. | 123.8° C. | 154.8° C. | 309.5° C. | 464.3° C. |
| 1.2 | S/m | 32.3° C. | 64.6° C. | 96.9° C. | 129.2° C. | 161.5° C. | 323.0° C. | 484.5° C. |
| 1.25 | S/m | 33.6° C. | 67.3° C. | 100.9° C. | 134.6° C. | 168.2° C. | 336.4° C. | 504.6° C. |

Table 3 shows that (with applied field held constant) as treatment time increases, or as the conductivity of the substance between the electrodes in the sterilization chamber increases, so too does the temperature rise of that substance. It is noted again that the temperature increases shown in Table 3 are given in degrees centigrade. Some of these temperature increases would bring fluids from near freezing (0° C.) to above boiling point of water (100° C.) for the treatment times, and thus would not be practical in actual use. For example, Table 1 shows that the conductivity of the natural fluids of an oyster is somewhere in the range of 1.15 to 1.20 S/m. Referring to Table 3, it is seen that treatment times greater than 400 μs of fluids having this level of conductivity result in temperature increases that could exceed the boiling point of the fluid. For these substances, the electric cleansing method described herein may not be practical where the treatment time is continuous. However, these substances may be cleansed in the manner described herein if the treatment time is broken up into a plurality of treatment times, e.g., two or more treatments of 200 μs each, with sufficient cooling to keep the fluid below its boiling point. Likewise, the fluid may be cooled by known methods between treatments to decrease its temperature between applications and therefore increase the overall treatment time without causing undue heating. Table 3 thus shows that for oysters skimmed and packaged in natural fluids having conductivity of approximately 0.36 S/m (see Table 1), a treatment time of 500 μs gives approximately a 47.1° C. temperature rise (about 117° F.). This treatment time is preferred as it is desirable not to raise the temperature much above room temperature to avoid cooking the oysters, as discussed above. However, multiple 500 μs pulses may be required to obtain complete killing of the bacteria, thus some forced cooling may be required between pulses. Indeed, for the electric fields and pulse lengths of the preferred embodiment (15 kV/cm, and 500 μs respectively), between one and twenty-five (25) pulses may be required to obtain complete killing of the bacteria.

As previously mentioned, the rinsing step of the oyster preparation process was believed to aid in the removal of bacteria from the outside of the oysters. However, this rinsing step also removed natural fluids associated with the oyster. It is believed that these fluids add to the raw oyster eating experience and it would therefore be desirable to have them as part of the raw oyster product. A second embodiment of the present invention addresses these shortcomings of the prior art by packing the rinsed and electric cleansed oysters in their own natural fluids to preserve the raw oyster flavor. The oysters are preferably electric cleansed as described above. In the prior art, washing or skimming the oysters meant running clean water over the oysters. As has been previously described, this not only removes the small shell particles and sand from the body of the oyster, but also removes the natural fluids. To achieve the goal of this embodiment of the invention, it is necessary to strain or otherwise filter the undesirable particles such as sand and shell from the natural fluids of the oyster. Referring to FIG. 4, there is shown an exemplary screening mechanism 50 of an embodiment of this invention. The screening mechanism 50 is preferably used to screen or filter the natural fluid of the oyster to remove shell, sand and other particles therefrom. Again, this was not a concern in the prior art because these natural fluids, along with any solids they contained, were simply washed away.

The screening mechanism 50 as shown in FIG. 4 preferably comprises an open upper end 52 and an open lower end 54. Within the screening mechanism 50 are three screens 56, 58 and 60. Each of these screens preferably attaches to the wall of the screening mechanism 50 such as by hinges 62, 64 and 66. The uppermost screen 56, preferably is a large mesh screen capable of removing only large particles from the natural fluids of the oyster. The middle screen 58 preferably has a screen mesh smaller than that of the upper screen 56, and correspondingly screen 58 removes some particles that simply pass through the upper screen 56. Finally, lower screen 60 preferably has a mesh size smaller than both the middle 58 and upper screens 56 and is designed to filter from the natural fluids of the oyster even the smallest pieces of sand and shell expected.

In operation, natural fluids of the oysters directly from the shuckers are preferably filtered, as by the screening mechanism 50, discussed above. The natural fluids, along with any particles therein, are preferably poured or otherwise applied through the upper end 52 of the screening mechanism 50. The natural fluids then flow through each of the three screens 56, 58 and 60 and exit through the lower end 54, preferably into another container or an electric cleansing treatment chamber described in great detail above. Screening mechanism 50 preferably has at least three screens because attempting to screen particles of various sizes with a single screen having a very fine mesh tends to clog the screen quickly. After a certain volume of the oysters have been screened through the screening mechanism 50, the screening mechanism 50 may be cleaned by placing its lower open end 54 in an upward orientation and flowing clean water through the mechanism in the reverse direction of the flow of natural fluids of the oyster. The reverse flow of water through the mechanism 50 dislodges the particles contained on the upper surfaces of the screens 56, 58 and 60, and also causes these screens to rotate about their hinges 62, 64 and 66 respectively to allow the particles to be flushed through the open end 52, which in the cleaning orientation is at the bottom. The oysters, separated prior to application of the natural fluids to the screen mechanism 50, are preferably skimmed as in the prior art.

The natural fluids of the oysters may be cleansed by any method of the prior art, or may be cleansed using the electric field method described in this patent. The oysters, cleansed by this electric cleansing method, and their natural fluids, cleansed by either an embodiment described herein or by one of the prior art, are then placed together in the shipping containers of the prior art.

While preferred embodiments of this invention have been shown and described, modifications thereof can be made by one skilled in the art without departing from the spirit or teaching of this invention. For example, an embodiment of the invention described above uses an electric field strength of 15,000 volts per centimeter. However, any electric field strength between approximately 5000 volts per centimeter and an upper limit set by the dielectric strength of the substance between the electrodes (for oysters, this upper limit is believed to be 30,000 V/cm), would still be within the contemplation of this invention. For practical reasons, however, electric field strengths between 10,000 volts per centimeter and 20,000 volts per centimeter are more desirable. Further, an embodiment of the invention described above indicates that 500 μs is a preferred treatment pulse time; however, at the field strengths indicated, total treatment times (summation of treatment time of individual pulses) from 100 to 10,000 μs could be used and still be within the contemplation of this invention. Further, although this invention has been described for use in an oyster shucking facility, there are other equally viable places for use of electric cleansing, all of which would be within the contemplation of this invention. Indeed, it is possible that rather than an otherwise DC signal, some or a portion of a high voltage AC signal could be applied to the plates or electrodes and still be within the contemplation of this invention. A smaller version of the electric cleansing unit may be used by individuals, restaurants and seafood wholesalers to cleanse oysters before consumption, and this would still be within the contemplation of this invention. The embodiments described herein are exemplary only and are not limiting. This description has exemplified that the pulse shape applied to the plates or electrodes is essentially that shown in FIG. 4; however, other voltage pulse shapes, e.g., square wave or saw-tooth, could be used and still be within the contemplation of this invention. It is noted that a system capable of square or saw-tooth pulses would require significantly more sophisticated hardware than that described in FIG. 1, yet such systems would still be within the contemplation of this invention. Many variations and modifications of the system and apparatus are possible and are within the scope of the invention. Accordingly, the scope of protection is not limited to the embodiments described herein, but is only limited by the claims that follow, the scope of which shall include all equivalents of the subject matter of the claims.

What is claimed is:

1. A method of cleansing bacteria from a shucked oyster which comprises exposing the shucked oyster to an electric field of sufficient strength to kill the bacteria.

2. The method as defined in claim 1 further comprising:
placing the shucked oyster in a defined volume;
creating an electric field which permeates the volume and which permeates the shucked oyster; and
killing bacteria present with the shucked oyster with the electric field.

3. The method as defined in claim 2 wherein said placing the shucked oyster in the volume further comprises placing the shucked oyster in a volume having a rectangular cross-section and having a width substantially the same as a thickness of the shucked oyster.

4. The method as defined in claim 3 further comprising placing the shucked oyster in the volume having a width of approximately one centimeter.

5. The method as defined in claim 2 wherein creating the electric field further comprises creating an electric field that has a peak electric field strength at its initial application, and which decays exponentially thereafter.

6. The method as defined in claim 5 further comprising creating a peak electric field strength in a range of approximately 10,000 volts per centimeter to 20,000 volts per centimeter.

7. The method as defined in claim 6 further comprising creating the peak electric field strength of approximately 15,000 volts per centimeter.

8. The method as defined in claim 2 wherein creating the electric field further comprises creating the electric field that lasts for approximately 500 micro-seconds.

9. A method of preparing oysters for consumption, comprising:
a) shucking the oysters from their shells to free the meat from shell; and
b) exposing the meat to a high strength electric field to kill the bacteria.

10. The method as defined in claim 9 wherein step b) further comprises:
exposing the meat to an electric field strength between approximately 5,000 volts per centimeter and 30,000 volts per centimeter.

11. The method as described in claim 10 further comprising:
exposing the meat to an electric field strength between approximately 10,000 volts per centimeter and 20,000 volts per centimeter.

12. The method as described in claim 11 further comprising:
exposing the meat to a field strength of approximately 15,000 volts per centimeter.

13. The method of preparing oysters as defined in claim 9 wherein step b) further comprises:
b1) placing the meat between two substantially parallel conductive plates;
b2) applying a large voltage across said two conductive plates; and thereby
b3) creating an electric field between the conductive plates which permeates the meat.

14. The method as defined in claim 13 wherein step b1) further comprises placing the meat between the two substantially parallel conductive plates with the spacing between the two plates of approximately one centimeter.

15. The method as defined in claim 13 wherein step b2) further comprises:
charging a capacitor;
coupling a first terminal of said capacitor to a first conductive plate of the two conductive plates; and
coupling a second terminal of said capacitor to a second conductive plate of the two conductive plates.

16. The method as defined in claim 15 wherein coupling the first terminal to the first conductive plate further comprises closing a high voltage firing switch.

17. A method of preparing bivalves for human consumption comprising:
harvesting oysters from oyster beds;
shucking said oysters to remove the oyster meat and natural fluids;
collecting the oyster meat and natural fluids until such collection amounts to a predetermined volume;
skimming the oyster meat and natural fluids;
placing the skimmed oysters in a treatment chamber formed on two sides by conductive plates having a spacing between them;
creating an electric field between the plates thereby making cleansed oysters; and
placing the cleansed oysters in shipping containers.

18. The method as defined in claim 17 wherein placing the cleansed oysters in the shipping containers further comprises filling any remaining volume in the shipping containers with fluid.

19. The method as defined in claim 18 further comprising filling the remaining volume of the shipping containers with natural fluids of the oysters, the natural fluids cleansed of bacteria.

20. The method as defined in claim 19 wherein the natural fluids of the oysters are cleansed by exposure to an electric field.

21. The method as defined in claim 17 wherein:
collecting the oyster meat and natural fluids further comprises collecting the oyster meat and natural fluids until a volume of approximately one gallon is collected; and
wherein placing the skimmed oysters in a treatment chamber further comprises placing them in a treatment chamber having a volume of approximately one gallon.

22. The method as defined in claim 21 wherein skimming the oyster meat and natural fluids further comprises placing the oyster meat and natural fluid on a screen and separating the natural fluids from the meat.

23. The method as defined in claim 22 further comprising:
collecting the skimmed natural fluids;
killing the bacteria in the natural fluids; and
placing the natural fluids in shipping containers with the cleansed oysters.

24. The method as defined in claim 23 wherein killing the bacteria in the natural fluids further comprises exposing the natural fluids to an electric field.

25. The method as defined in claim 17 wherein creating the electric field between the plates further comprises placing a large voltage across the plates.

26. The method as defined in claim 25 further comprising placing a voltage of approximately 15,000 volts across said plates.

27. A structure for electric cleansing of bacteria from bivalves comprising:
a charging network;
a voltage control network;
an application chamber having an internal volume containing meat of raw oysters, each meat having a thickness;
said application chamber having at least five sides comprising:
two conductive plates forming two opposing vertical sides having a separation substantially the same as the thickness of the meat of the raw oyster;
two non-conductive members attached to the conductive plates and forming a remaining two vertical sides; and
a bottom formed of perforated non-conductive material.

28. The structure as defined in claim 27 wherein said charging network further comprises:
a step-up transformer having a 120 Volt rms (low voltage) primary and a 15,000 Volt peak (high voltage) secondary;
a rectification circuit coupled to said secondary of said step-up transformer; and
a capacitor coupled to a rectified output line of said rectification circuit.

29. The structure as defined in claim 27 wherein said voltage control network further comprises a high voltage power switch coupling a positive terminal of said capacitor to one of said substantially parallel plates and for selectively applying the charge stored on said capacitor to said plate.

30. The structure as defined in claim 29 wherein a voltage applied by said capacitor when applying the charge stored on the capacitor is a decaying exponential.

31. The structure as defined in claim 27 wherein the two conductive plates are substantially parallel.

32. The structure as defined in claim 31 wherein said two substantially parallel conductive plates are constructed of food grade stainless steel.

33. The structure as defined in claim 31 wherein the separation between the two conductive plates is approximately one centimeter.
